(19) United States
(12) Patent Application Publication
(10) Pub. No.: US 2006/0128916 A1
(43) Pub. Date: Jun. 15, 2006

(54) LCST polymers

(76) Inventor: Matthias Schrod, Eppertshausen (DE)

Correspondence Address: Scott R Cox;Lynch Cox Gilman & Mahan, 500 West Jefferson St, Suite 2100, Louisville, KY, 40202, US

(21) Appl. No.: 10/535,768

(22) PCT Filed: Nov. 21, 2003
(86) PCT No.: PCT/EP03/13099

§ 371 Date: Nov. 23, 2005

(30) Foreign Application Priority Data
Nov. 21, 2002 (DE) 102 54 432.8

(51) Int. Cl. C08F 26/06; C08F 226/06

(52) U.S. Cl. 526/258

(57) ABSTRACT

A description is given of LCST polymers obtainable by free-radical co- or terpolymerization in aqueous or alcoholic solution of
A) about 45.0 to 99.9 mol % of at least one monomer or macromonomer featuring the structural unit 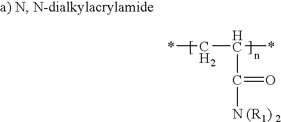
in which n is 1 to 10 000 and R₁ (identical or different at each occurrence) is hydrogen or alkyl groups having 1 to 5 carbon atoms, and the radicals R₁ can also form a ring together with the nitrogen atom; 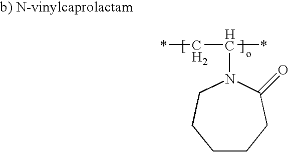
in which o is 1 to 10 000; 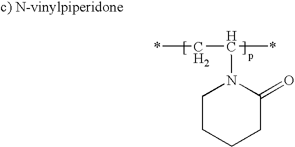
in which p is 1 to 10 000; 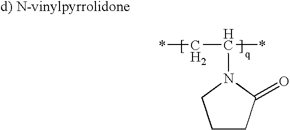
in which q is 1 to 10 000; 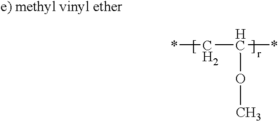
in which r is 1 to 10 000; 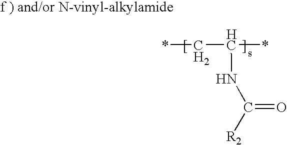
in which s is 1 to 10 000 and R₂ is an (iso)alkyl group having 1 to 5 carbon atoms or a cyclopentyl group; B) about 0.1 to 55.0 mol % of a comonomer from the group of a) maleic acid, maleic anhydride or an alkyl ester of maleic acid in which the alkyl group contains 1 to 5 carbon atoms; b) fumaric acid or an alkyl ester of fumaric acid in which the alkyl group contains 1 to 5 carbon atoms; c) acrylic or methacrylic acid or an alkyl acrylate or methacrylate in which the alkyl group contains 1 to 5 carbon atoms; d) a hydroxyalkyl acrylate or methacrylate in which the alkyl group contains 1 to 5 carbon atoms; e) vinyl acetate; f) glycidyl (meth)acrylate; g) allyl glycidyl ether; and/or h) α,α-dimethyl-meta-isopropenylbenzyl isocyanate; the polymer obtained by copolymerizing the monomers or macromonomers (A) and (B) being derivatized by means of a derivatizing agent containing at least one group which is able to react with a group of a repeating unit originating from the comonomer (B), to form a covalent bond, and also at least one polymerizable double bond. A description is further given of processes for their preparation and also of their use to coat particles and nonparticulate substrate surfaces.

The invention relates to LCST (lower critical solution temperature) polymers. This term is used to refer to polymers which are soluble in a liquid medium at a low temperature but which above a certain temperature (the LCST temperature) precipitate from the liquid medium. LCST polymers have different chemical compositions. The best-known LCST polymers are polyalkylene oxide polymers, examples being polyethylene oxide (PEO) or polypropylene oxide (PPO) polymers, but also (PEO)-(PPO) copolymers, especially PEO-PPO-PEO block copolymers. Other LCST polymers are poly(N-isopropyl-acrylamide)-ethyl-(hydroxyethyl)-cellulose derivatives, poly(N-vinylcaprolactam) derivatives and poly(methyl vinyl ether) derivatives.

The first-mentioned polymers are described for example in WO 01/60926 A1. That publication relates to a process for coating substrate surfaces (particle surfaces and nonparticulate substrate surfaces) with LCST polymers, for which an LCST polymer is dissolved in a solvent at a temperature below the LCST temperature, this solution is mixed with the substrate surfaces to be coated, and the resulting mixture is heated to above the LCST temperature until the deposition of LCST polymers on the substrate surfaces begins. The deposited LCST polymer can be immobilized by providing it with functional groups which allow substantially irreversible adsorption on the substrate surface. The functional groups can be selected from acid groups, hydroxyl groups, amino groups, phosphate groups, mercaptan groups, siloxane groups or hydrophobic groups. Further, the LCST polymers can be provided with functional groups which, following deposition of the LCST polymers on the particles, allow the crosslinking of the LCST polymers in a crosslinking reaction. Functional groups of this kind can be selected from carboxylic acid group derivatives, chloroformate groups, amino groups, isocyanate groups, oxirane groups and/or free-radically crosslinkable groups, the crosslinking reaction being initiated, inter alia, by a change in the pH of the solution.

Free-radical crosslinking is less preferred than crosslinking as a result of the change in pH. The examples indicate merely the enveloping of various pigment particles (TiO₂, Fe₂O₃, Cu phthalocyanine blue and also semiconductor wafers having a silicon dioxide surface) with PEO-PPO-PEO block copolymers. Fixing of the copolymers deposited on the substrate surfaces is not illustrated.

The use of LCST polymers for enveloping superpara-magnetic particles is known, further, from WO 97/45202. These particles comprise a core of a first polymer, an inner layer of a second polymer, which coats the core and in which a magnetic material is dispersed, and an outer layer of a third polymer, which coats the magnetic layer and is capable of reacting with at least one biological molecule, the second polymer at least being heat-sensitive and having an LCST temperature of 15 to 65° C. The second polymer is preferably obtained by polymerizing (1) a water-soluble acrylamide monomer, such as N-isopropylacrylamide (NIPAM), (2) at least one crosslinking agent, such as N,N-methylenebisacrylamide, and (3) at least one functional cationic and water-soluble monomer which is different from the monomer (1), an example being the chloride of 2-aminoethyl methacrylate. A further preferred polymer is [poly-(N-isopropylacrylamide)] (PNIPAM).

“Patent Abstracts of Japan”, Vol. 009 No. 188 (C295) (1985) page 107=JP 60 058 237 A describes the encapsulation of inorganic particles. The aim is to prepare a stable particle dispersion. The inorganic particles are suspended in water and contacted below the LCST temperature with an aqueous solution of the LCST polymer. If the temperature of the resulting system is raised, a layer of the LCST polymer is deposited on the inorganic particles. The resulting particle suspension is admixed with a free-radically polymerizable monomer, an initiator and, if desired, an emulsifier, and an emulsion polymerization is carried out, giving encapsulated particles. Additionally, then, there is the polymerized monomer layer as an outer layer, so that the function of the LCST polymer layer is only to facilitate the penetration of monomer radicals.

The polymerizable monomer is therefore reacted with the LCST polymer that is already on the particles, or the water-soluble polymer is enveloped with a layer of the polymer obtained from the polymerizable monomer. This process has the disadvantage that the graft attachment takes place only on the active centers of the pre-deposited LCST polymer, as a result of which the envelopment is nonuniform and heterogeneous and does not constitute a complete barrier.

Furthermore, it is necessary to add a monomer to the dispersion of the coated particles in order to initiate crosslinking. In the majority of cases the monomer is never completely consumed, so that a certain portion of the monomer remains in the crosslinked structure. Subsequent emission of the “dissolved” monomers from the polymer is undesirable, since the monomer is injurious to health.

Moreover, disadvantages in the paint system are to be expected as a result of the detachment of the copolymerized emulsifier if the pigment comes into contact with solvents.

WO 92/20441 describes a process for producing encapsulated particles, the particles comprising a core surrounded by a coacervate coating. In this process an aqueous solution of an LCST polymer is contacted at a temperature of reversible insolubilization (TRI) of T1, with a dispersion of the particles at a temperature of T2, which is lower than T1, and then the dispersion is heated to a temperature above T1, thereby depositing the LCST polymer as a coacervate around the particles. An agent for lowering the TRI is then added to the solution, the TRI of the LCST polymer in the solution being lowered to a temperature T3, which is lower than T1, and subsequently either the dispersion is cooled to a temperature between T3 and T1, and maintained at that temperature, or the particles are separated from the dispersion at a temperature of more than T3. As agents for lowering the TRI it is possible to use electrolytes and water-miscible organic liquids in which the LCST polymer is not soluble.

LCST polymers used are preferably synthetic polymers (homopolymers or copolymers) with hydrophilic monomers. Suitable LCST monomers are acrylic or vinyl compounds. Where LCST copolymers are used, the comonomer is commonly hydrophilic and may be nonionic or ionic. Suitable nonionic monomers are certain acrylic or vinyl compounds. Anionic or cationic monomers are, for example, acrylic acid derivatives or dialkylaminoalkyl acrylates. These compounds, however, are already saturated at the ends, so that crosslinking reactions are no longer possible.

LCST polymers are also known, for example, from EP 0 629 649 A1. They are used as rheofluidifying additives and antisettling agents in diaphragm wall construction, for wells in the oil industry, and as hydraulic fluids and lubricants.

EP 0 718 327 A2 discloses universally compatible pigment dispersants which are composed of methyl methacrylate and an acrylate or methacrylate. These polymers, however, serve only for dispersing pigments, but not for enveloping pigments.

DE 198 02 233 A1 describes gels having thermotropic properties that are used, for example, for glazing systems, in order to achieve darkening as a function of insolation. The gels comprise an LCST polymer which is composed of 60%-99.9% by weight of ethylenically unsaturated lactams or vinyl ethers (monomer A), 0-20% by weight of ethylenically unsaturated compounds having a crosslinking action (monomer B), 0.1%-30% by weight of monomers containing at least one acid or acid anhydride group (monomer C) and 0-20% by weight of further monomers D. Preferably the LCST polymer comprises only monomers A and C, so that the LCST polymer is not crosslinked on irradiation. For preparing the gel a solution is prepared from the LCST polymer and from a free-radically polymerizable monomer (b) and the solution is irradiated with high-energy light. In the course of this irradiation the monomer (b) forms a three-dimensional network, i.e., a gel, which is insoluble or virtually insoluble in the chosen solvent or solvent mixture. The network formed from the monomer (b) incorporates the LCST polymer, so giving a thermotropic gel which is crosslinked in a very wide-meshed fashion. The gel must be capable of being applied between the glass plates and must fill the space between the glass plates.

A similar polymer system is described in DE 197 19 224 A1. It describes a layer structure in which a thermotropic polymer system is disposed between an inner transparent glass sheet and an outer transparent glass sheet, which in other words is exposed to natural sunlight. The thermotropic polymer system is protected in the long term against UV light exposure by means of a UV protection layer. There again the thermotropic polymer system is composed of a gel with wide-mesh crosslinking.

DE 197 00 064 A1 describes gels with thermotropic properties, obtained by irradiating a mixture comprising an uncrosslinked polymer, free-radically polymerizable monomers, water or an organic solvent or mixtures thereof, and at least one specific photo-initiator. There again an LCST polymer is incorporated into a wide-mesh gel structure which is prepared from the free-radically polymerizable monomers. The gel is intended for use as a thermotropic layer in glazing systems.

DE 196 01 085 A1 describes gels with thermotropic properties which are likewise intended for use for glazing systems. The gels are obtained by irradiating a mixture comprising (a) an uncrosslinked polymer in amounts below 5% by weight, based on the sum of (a), (b) and (c), (b) free-radically polymerizable monomers, and (c) water or an organic solvent or mixtures thereof. There again the LCST polymer is incorporated in a wide-meshed network formed from the free-radically polymerizable monomer.

DE 196 01 084 Al describes gels for thermotropic layers which are obtained by irradiating a mixture with high-energy light. The mixture comprises an uncrosslinked polymer having a number-average molecular weight Mn of 1000 to 30 000 g/mol (LCST polymer), free-radically polymerizable monomers and water or an organic solvent or mixtures thereof. These gels are likewise intended for use in glazing systems as a thermotropic layer. There again a gel is formed with the LCST polymer incorporated in its wide-meshed structure.

In the case of the thermotropic gels described above for glazing systems, the LCST polymer is intended to retain its thermotropic properties even in the gel, so that it can be precipitated and dissolved repeatedly, so as to allow as high as possible a number of shading/lightening cycles. A gel of this kind is not suitable for the formation of coatings.

One further such system is described in DE 44 14 088 A1. These gels as well include an LCST polymer which is incorporated in a gel which is produced by polymerizing free-radically polymerizable monomers in a suitable solvent, such as water or an organic solvent.

The object on which the invention was based was to provide LCST polymers which on cooling no longer detach from a substrate surface but instead remain firmly joined to it. The polymers should therefore be used without additions of emulsifiers or monomers, so that no additives can be leached from the defined polymer layer.

This object is achieved in accordance with the invention by means of LCST polymers which are obtainable by free-radical polymerization of
A) about 45.0 to 99.9 mol % of at least one monomer or macromonomer featuring the structural unit 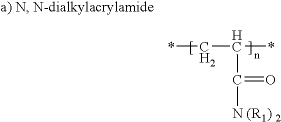
   in which n is 1 to 10 000 and R₁ (identical or different at each occurrence) is hydrogen or alkyl groups having 1 to 5 carbon atoms, and the radicals R₁ can also form a ring together with the nitrogen atom; 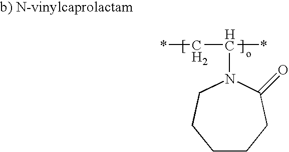
   in which o is 1 to 10 000; 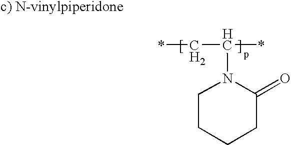
   in which p is 1 to 10 000; 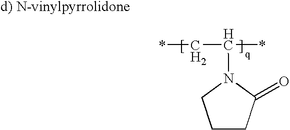
   in which q is 1 to 10 000; 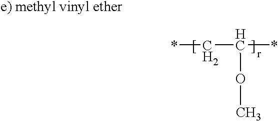
   in which r is 1 to 10 000; 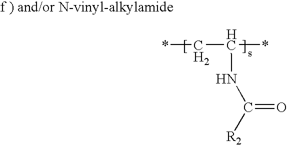
   in which s is 1 to 10 000 and R₂ is an (iso)alkyl group having 1 to 5 carbon atoms or a cyclopentyl group;
B) about 0.1 to 55.0 mol % of a comonomer from the group of
   a) maleic acid, maleic anhydride or an alkyl ester of maleic acid in which the alkyl group contains 1 to 5 carbon atoms;
   b) fumaric acid or an alkyl ester of fumaric acid in which the alkyl group contains 1 to 5 carbon atoms;
   c) acrylic or methacrylic acid or an alkyl acrylate or methacrylate in which the alkyl group contains 1 to 5 carbon atoms;
   d) a hydroxyalkyl acrylate or methacrylate in which the alkyl group contains 1 to 5 carbon atoms;
   e) vinyl acetate;
   f) glycidyl (meth)acrylate;
   g) allyl glycidyl ether; and/or
   h) α,α-dimethyl-meta-isopropenylbenzyl isocyanate;
      the polymer obtained by copolymerizing the monomers or macromonomers (A) and (B) being derivatized by means of a derivatizing agent containing at least one group which is able to react with a group of a repeating unit originating from the comonomer (B), to form a covalent bond, and also at least one polymerizable double bond.

By “macromonomers” are meant copolymers which are still capable of further polymerization, which is not always the case for certain copolymers. These macromonomers therefore still comprise, for example, a reactive polymerizable double bond.

In the preparation of the LCST polymers of the invention first of all, from the monomers or macromonomers (A) and (B), a polymer is prepared which generally already has LCST properties. This reaction is generally carried out in solution. Depending on the solubility of the polymer it is possible for instances of turbidity to arise during the reaction. These turbidities do not, however, substantially affect the structure or properties of the polymer. To prepare this polymer a suitable solvent is selected in which both the monomers or macromonomers (A) and (B) and the polymer are soluble, so that the reaction proceeds largely homogeneously. Suitable examples include water or alcohols, such as methanol, ethanol or isopropanol, or else mixtures of these solvents. Aliphatic or aromatic solvents can also be used. Aromatic solvents are preferred on account of their better solvency properties. Examples of suitable aromatic solvents are toluene or the xylenes. The use of aliphatic or aromatic solvents is especially preferred when the polymer comprises reactive groups for the derivatization that are able to react with water or alcohols. Solvent mixtures can also be used here. As well as the solvents specified, other solvents too can be used.

The polymer prepared in the first stage may comprise only one monomer from each of the groups (A) and (B) indicated above. It is also possible, however, for two or more monomers from the above-indicated groups (A) and (B) to be included in the polymer. Accordingly the polymer is obtained by copolymerization or terpolymerization. Polymerizations with more than three different monomers can be carried out where appropriate.

The monomers included in group (A) have a different polarity, so that through the ratio of the individual monomers (or macromonomers) it is possible to influence the LCST temperature of the LCST polymer. For instance, the monomer ((A, d); N-vinylpyrrolidone) has relatively polar properties and leads to an increase in the LCST temperature, whereas the monomer ((A, b); N-vinylcaprolactam) has much more nonpolar properties, and so leads to lower LCST temperatures of the LCST polymer. Preference is given to using the monomer ((A, d); N-vinylpyrrolidone) together with another monomer of group (A), very preferably in combination with one or both of the monomers ((A, b); N-vinylcaprolactam) and ((A, c); N-vinylpiperidone) and very preferably in combination with the monomer ((A, b); N-vinylcaprolactam). The chosen fraction of the monomer ((A, d); N-vinylpyrrolidone) as a proportion of the monomers of group (A) is preferably less than 70 mol %, in particular less than 60 mol %, and with more particular preference less than 50 mol %.

The monomers of group (B) introduce groups which allow subsequent derivatization of the polymer. Besides a polymerization double bond, therefore, the monomers of group (B) include at least one reactive group which on the one hand does not disrupt the polymerization reaction and on the other hand remains within the polymer in order to allow reaction with a derivatizing agent. Through the polarity of the monomers of group (B) it is possible, further, to influence the LCST of the LCST polymer.

The polymerization of the monomers of groups (A) and (B) is followed by derivatization of the polymer, through which pendent polymerizable double bonds are introduced into the polymer. The compounds with which the polymer is derivatized have on the one hand a polymerizable double bond and on the other hand a reactive group which allows their attachment to the backbone of the polymer. This attachment is via the reactive group introduced by the monomers B. The compounds preferably have a molecular weight in the range from 50 to 300. The introduction of these compounds does not substantially affect the LCST properties of the LCST polymer. The reactive group of the derivatizing agent is selected in accordance with the group introduced into the polymer by the monomer of group (B). If a carboxyl group, a carboxylic ester group, a carboxylic anhydride group, an epoxy group or an isocyanate group has been provided on the polymer, then the derivatizing agent preferably comprises a hydroxyl group or an amino group. For the derivatization, therefore, unsaturated alcohols or amines are used with preference. If the reactive group introduced into the polymer by the monomer of group (B) was a hydroxyl group, the derivatizing agent comprises, accordingly, a carboxyl group, a carboxylic ester group, a carboxylic anhydride group or another activated carboxylic acid group, or else an epoxy group or an isocyanate group.

Following the derivatization, the LCST polymer possesses pendent groups with polymerizable double bonds. The advantage of the LCST polymers of the invention therefore lies in the fact that, following deposition on a surface, they can still be crosslinked further, in which case a very high degree of crosslinking can be achieved.

In one embodiment of the LCST polymer of the invention at least a proportion of the monomers of group (B) is replaced by butadiene. This has the advantage that the pendent polymerizable double bonds need not be introduced in a separate derivatization step but, instead, these pendent polymerizable double bonds are introduced as early as during the polymerization of the monomers or macromonomers of groups (A) and (B).

The structural unit formed from the comonomers (B) (a) to (c) can be derivatized by transesterification with allyl alcohol, hydroxymethyl acrylate, hydroxymethyl methacrylate, hydroxyethyl acrylate, hydroxyethyl methacrylate or 3-amino-1-propanol vinyl ether.

The structural units formed from the comonomer (B) (d) can be derivatized by esterification with acrylic acid or with methacrylic acid or by transesterification with C₁-C₁₀ alkyl acrylates or methacrylates.

The structural unit formed from the comonomer (B) (e) can be derivatized by transesterification with acrylic acid, methacrylic acid or C₁-C₁₀ alkyl acrylates or methacrylates.

The structural unit formed from the comonomer (B) (f) needs no derivatization.

The structural unit formed from the comonomer (B) (g) and/or (h) or its OH-functional or NH-functional derivatives can be derivatized by reaction with (meth)acrylic acid.

The structural units formed from the comonomer (B) (a) to (c) and comprising a carboxylic acid group can be derivatized by reaction with glycidyl (meth)acrylate and/or allyl glycidyl ether.

The structural units formed from the comonomer (B) with OH and/or NH functionalities can be derivatized with α,α-dimethyl-meta-isopropenylbenzyl isocyanate. In one embodiment of the invention, for example, the structural unit formed from the comonomer (B) (d) is derivatized by reaction with α,α-dimethyl-meta-isopropenylbenzyl isocyanate.

For the LCST polymers it is not possible to give precise formulae, since the monomers are generally arranged in a random distribution in the polymer chain. The polymer chain may also, however, be composed of blocks of the same monomers.

It has surprisingly been found that, following the polymerization and derivatization of the comonomers (B) (a) to (B) (i), the polymers of the invention are immobilized irreversibly on the substrate surface. The immobilization is far greater than that of LCST polymers in which the end groups are composed, for example, of simple vinyl groups or other groups with double bonds. Substantially more than two polymerizable groups in the molecule are available for immobilizing the polymers. As a result of the presence of numerous double bonds, the crosslinking density becomes greater than in the case of only two (terminal) groups. A further point is that, owing to the tighter crosslinking (high crosslinking density), the swelling of the polymer immobilized on the pigment in (aqueous) solvents is substantially lower. This is a great advantage when the coated pigments are incorporated into paints, since paint defects, such as blistering and swelling, occur to a lesser extent.

The polymers of the invention commonly have an LCST in the range from 7 to 70° C., which is dependent on factors including the following:
molar ratio of the hydrophobic and hydrophilic fractions of the LCST polymer,
molar mass of the LCST polymer,
number of polymerizable and ionizable groups,
concentration of the polymer,
pH and ionic strength of the medium.

The LCST polymers are composed of polar and nonpolar or hydrophilic and hydrophobic segments. The LCST can be tailored by varying these individual segments and also the overall chain length.

Following the polymerization and derivatization, the LCST polymers of the invention can be used as dispersants fixed on the substrate surfaces. In this way, the expensive step of the pigment dispersion, among others, becomes cheaper, since the pigment carries its dispersant with it. Further, the pigments thus coated form agglomerates to a lesser extent than do untreated pigments, and so dispersion is easier to carry out, resulting in an additional reduction in costs.

Dispersants are surface-active substances which facilitate the dispersion of a pulverulent substance, such as a pigment or filler, for example, in a liquid dispersion medium by lowering the surface tension between the two components. As a result, in the course of pigment dispersion, they facilitate the mechanical disruption of the secondary particles, which are present in the form of agglomerates, into primary particles. Furthermore, they protect the primary particles formed from reagglomeration or flocculation, by virtue of complete wetting and formation of a protective colloid shell or an electrochemical double layer.

Since the LCST polymers of the invention are transparent or translucent in visible light, they are able to form a complete envelope around particles without affecting the color of the particles themselves. Moreover, in paints, pigments thus coated display the full color strength, since by virtue of the LCST polymer coating they do not form agglomerates.

The LCST polymers of the invention can be prepared by free-radical polymerization and subsequent derivatization. In this case about 45.0 to 99.9 mol %, preferably about 75 to 99 mol %, of at least one monomer or oligomer from group (A), together with about 0.1 to 55.0 mol %, preferably about 1 to 25 mol %, of the comonomer (B) are used. The polymerization is carried out preferably in solution.

It is also possible in this context to use mixtures of the monomers (A) and comonomers (B) . The copolymers of the invention can be prepared by free-radical polymerization in aqueous or alcoholic solution. Preference is given here to low molecular mass alcohols (C₁ to C₅), since they can be stripped off easily. Where the comonomers of group (B) include reactive groups which are able to react with alcohols or water, such as an epoxy group or an isocyanate group, for example, the solvents used may also include aliphatic or aromatic hydrocarbons, with aromatic hydrocarbons being preferred. Examples of suitable aromatic solvents are toluene or xylene. The polymerization takes place in the presence of compounds which form free radicals, the polymerization initiators, such as organic peroxide or azo compounds or inorganic peroxide compounds. The molar mass of the resultant copolymer is influenced by adding suitable polymerization regulators, such as mercaptan, organic halogen compounds or aldehydes. The polymerization is generally conducted at temperatures of 50 to 100° C., preferably at temperatures of 60 to 80° C.

The LCST polymers of the invention can be used to coat particles and nonparticulate substrate surfaces. The particles that are suitable in accordance with the invention include pigments, fillers and nanoparticles. Pigments are pulverulent or platelet-shaped colorants, which in contrast to dyes are insoluble in the surrounding medium (DIN 55943: 1993-11, DIN:EN 971:1 1996-09). Pigments influence or determine the coloration and for reasons of cost are used in amounts as low as possible. Forces of interaction may cause the pigment particles to agglomerate, particularly during incorporation into the matrix material. This results, for example, in quality detractions in the resulting paint, as a result, among other things, of deficient color strength, sedimentation or phase separation.

Preferred pigments are titanium dioxide, iron oxide, zinc oxide, carbon black, Cu phthalocyanine pigments, platelet-shaped pigments, such as mica (with or without oxidic and metallic coatings) or aluminum. Examples of fillers which can be used include barium sulfate and talc. Nanoparticles which can be used include iron oxide, titanium dioxide and silicon dioxide particles and also nanoclays. Nanoclays are composed, for example, of montmorillonite, bentonite, synthetic hectorite or hydrotalcite. They have an extent of less than 1 μm along their longest extent. Preferably they have a length of several 100 nm and a thickness of less than 10 nm. Nanoclays possess very high aspect ratios of up to 1000. The particles also include microfibers, such as glass, carbon, textile and polymer fibers.

The substrate surfaces may also be nonparticulate surfaces, such as those of glass, metal and semiconductors, for example. Particularly preferred surfaces are silicon dioxide wafers used in the semiconductor industry.

The LCST polymers of the invention are preferably contacted in a liquid medium (e.g., in an aqueous or organic medium) at below the LCST temperature with the particles or with the nonparticulate substrate surfaces, and then the temperature is raised to above the LCST temperature and the polymers are polymerized by the double bonds at this temperature or a higher temperature on the surface of the particles or on the nonparticulate substrate surfaces.

The invention further provides particles or nonparticulate substrate surfaces coated with the polymerized LCST polymer.

The invention is illustrated without restriction by the examples which follow.

### EXAMPLE 1

### Copolymer of 90 mol % N,N-diethylacrylamide and 10 mol % Maleic Anhydride

In a 1-liter three-necked flask provided with stirrer, reflux condenser and nitrogen feed line, 250 g of N,N-diethylacrylamide, 21.42 g of maleic anhydride and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer can be modified by esterification in accordance with the prior art. For that purpose the copolymer is dissolved in 500 ml of toluene and the solution is mixed with 25.37 g of allyl alcohol. The alcohol can also be added in portions or continuously during the reaction. Further, the mixture is admixed with 0.1% to 5% by weight of esterification catalyst (sulfuric acid, hydrochloric acid, p-toluenesulfonic acid, dodecylbenzenesulfonic acid, alkaline (earth) metal (hydr)oxides or metal alkoxides) . The esterification is carried out at liquid-phase temperatures of 80 to 120° C. To prevent unwanted polymerizations the reaction is advantageously carried out in the presence of small amounts of commercially customary polymerization inhibitors (e.g., hydroquinone monoalkyl ethers, 2,6-di-t-butylphenol, N-nitrosamine, phenothiazine or phosphoric esters). These compounds are used in amounts of 0.01% to 2.0%, based on the amounts of the ester. The product obtained has an LCST of about 29° C.

### EXAMPLE 2

### Copolymer of 90 mol % N,N-diethylacrylamide and 10 mol % Dimethyl Fumarate

In a 1-liter three-necked flask provided with stirrer, reflux condenser and nitrogen feed line, 250 g of N,N-diethylacrylamide, 31.48 g of dimethyl fumarate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with allyl alcohol, using a transesterification catalyst and a polymerization inhibitor, as according to Example 1. The product obtained has an LCST of about 29° C.

### EXAMPLE 3

### Copolymer of 90 mol % N,N-diethylacrylamide and 10 mol % Hydroxyethyl Methacrylate

In a 1-liter three-necked flask provided with stirrer, reflux condenser and nitrogen feed line, 250 g of N,N-diethylacrylamide, 28.42 g of hydroxyethyl methacrylate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with 21.87 g of methyl methacrylate (instead of allyl alcohol), using a transesterification catalyst and a polymerization inhibitor, as according to Example 1. The product obtained has an LCST of about 24° C.

### EXAMPLE 4

### Copolymer of 90 mol % N,N-diethylacrylamide and 10 mol % Butadiene

In a 1-liter three-necked flask provided with stirrer, reflux condenser and nitrogen feed line, 250 g of N,N-diethylacrylamide and 8 g of dodecyl mercaptan are dissolved in 500 ml of ethanol and flushed with nitrogen. 2 g of dibenzoyl peroxide are added and the mixture is heated at the boiling point of the ethanol for 12 h; in the course of this heating, 11.82 g of butadiene in gaseous form are introduced. The copolymer is isolated by stripping off the solvent under reduced pressure. The product obtained has an LCST of 31° C.

### EXAMPLE 5

### Copolymer of 90 mol % N-vinylcaprolactam and 10 mol % Maleic Anhydride

In a 1-liter three-necked flask provided with stirrer, reflux condenser and nitrogen feed line, 250 g of N-vinylcaprolactam, 19.57 g of maleic anhydride and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by esterification with allyl alcohol, using a transesterification catalyst and a polymerization inhibitor, as according to Example 1. The product obtained has an LCST of about 28° C.

### EXAMPLE 6

### Copolymer of 90 mol % N-vinylcaprolactam and 10 mol % Dimethyl Fumarate

In a 1-liter three-necked flask provided with stirrer, reflux condenser and nitrogen feed line, 250 g of N-vinylcaprolactam, 28.76 g of dimethyl fumarate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with allyl alcohol, using a transesterification catalyst and a polymerization inhibitor, as according to Example 1. The product obtained has an LCST of about 28° C.

### EXAMPLE 7

### Copolymer of 90 mol % N-vinylcaprolactam and 10 mol % Hydroxyethyl Methacrylate

In a 1-liter three-necked flask provided with stirrer, reflux condenser and nitrogen feed line, 250 g of N-vinylcaprolactam, 25.97 g of hydroxyethyl methacrylate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with 21.87 g of methyl methacrylate, using a transesterification catalyst and a polymerization inhibitor, as according to Example 1. The product obtained has an LCST of about 19° C.

### EXAMPLE 8

### Copolymer of 90 mol % N-vinylcaprolactam and 10 mol % Butadiene

In a 1-liter three-necked flask provided with stirrer, reflux condenser and nitrogen feed line, 250 g of N-vinylcaprolactam and 8 g of dodecyl mercaptan are dissolved in 500 ml of ethanol and flushed with nitrogen. 2 g of dibenzoyl peroxide are added and the mixture is heated at the boiling point of the ethanol for 12 h. In the course of this heating, 10.79 g of butadiene (in gaseous form) are introduced. The copolymer is isolated by stripping off the solvent under reduced pressure. The product obtained has an LCST of 30° C.

### EXAMPLE 9

### Copolymer of 90 mol % methyl vinyl ether and 10 mol % Maleic Anhydride

In a 1-liter three-necked flask provided with stirrer, reflux condenser and nitrogen feed line, 250 g of methyl vinyl ether, 46.9 g of maleic anhydride and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by esterification with allyl alcohol, using a transesterification catalyst and a polymerization inhibitor, as according to Example 1. The product obtained has an LCST of about 25° C.

### EXAMPLE 10

### Copolymer of 90 mol % methyl vinyl ether and 10 mol % Dimethyl Fumarate

In a 1-liter three-necked flask provided with stirrer, reflux condenser and nitrogen feed line, 250 g of methyl vinyl ether, 68.93 g of dimethyl fumarate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with allyl alcohol, using a transesterification catalyst and a polymerization inhibitor, as according to Example 1. The product obtained has an LCST of about 25° C.

### EXAMPLE 11

### Copolymer of 90 mol % methyl vinyl ether and 10 mol % Hydroxyethyl Methacrylate

In a 1-liter three-necked flask provided with stirrer, reflux condenser and nitrogen feed line, 250 g of methyl vinyl ether, 62.24 g of hydroxyethyl methacrylate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with 21.87 g of methyl methacrylate, using a transesterification catalyst and a polymerization inhibitor, as according to Example 1. The product obtained has an LCST of about 16° C.

### EXAMPLE 12

### Copolymer of 90 mol % N-vinylcaprolactam and 10 mol % Butadiene

In a 1-liter three-necked flask provided with stirrer, reflux condenser and nitrogen feed line, 250 g of N-vinylcaprolactam and 8 g of dodecyl mercaptan are dissolved in 500 ml of ethanol and flushed with nitrogen. 2 g of dibenzoyl peroxide are added and the mixture is heated at the boiling point of the ethanol for 12 h. In the course of this heating, 10.79 g of butadiene (in gaseous form) are introduced. The copolymer is isolated by stripping off the solvent under reduced pressure. The product obtained has an LCST of 24° C.

### EXAMPLE 13

### Copolymer of 90 mol % N-vinyl-n-butyramide and 10 mol % Maleic Anhydride

N-Vinyl alkyl amides, such as N-vinyl-n-butyramide, are prepared by a two-stage reaction. This is done by pyrolyzing 1 mol of acetaldehyde, 1 mol of isopropanol and 1 mol of n-butyramide in the presence of catalytic amount of concentrated sulfuric acid at 500° C. to give N-vinyl-n-butyramide. The precise mechanism is specified in K. Suwa, Y. Wada, Y. Kikunaga, K. Morishita, A. Kishida, M. Akashi, J. Plym. Sci., Part A: Plym. Chem. Ed., 35, 1763 (1997).

In a 1-liter three-necked flask provided with stirrer, reflux condenser and nitrogen feed line, 250 g of N-vinyl-n-butyramide, 24.08 g of maleic anhydride and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by esterification with allyl alcohol, using a transesterification catalyst and a polymerization inhibitor, as according to Example 1. The product obtained has an LCST of about 29° C.

### EXAMPLE 14

### Copolymer of 90 mol % N-vinyl-n-butyramide and 10 mol % Dimethyl Fumarate

In a 1-liter three-necked flask provided with stirrer, reflux condenser and nitrogen feed line, 250 g of N-vinyl-n-butyramide, 35.39 g of dimethyl fumarate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with allyl alcohol, using a transesterification catalyst and a polymerization inhibitor, as according to Example 1. The product obtained has an LCST of about 29° C.

### EXAMPLE 15

### Copolymer of 90 mol % N-vinyl-n-butyramide and 10 mol % Hydroxyethyl Methacrylate

In a 1-liter three-necked flask provided with stirrer, reflux condenser and nitrogen feed line, 250 g of N-vinyl-n-butyramide, 31.95 g of hydroxyethyl methacrylate and 8 g of dodecyl mercaptan are dissolved in 500 ml of toluene and flushed with nitrogen. 2 g of dibenzoyl peroxide are added and the mixture is heated at the boiling point of the toluene for 12 h. The copolymer is isolated by stripping off the solvent under reduced pressure.

The copolymer is modified by transesterification with 21.87 g of methyl methacrylate, using a transesterification catalyst and a polymerization inhibitor, as according to Example 1. The product obtained has an LCST of about 24° C.

### EXAMPLE 16

### Copolymer of 90 mol % N-vinyl-n-butyramide and 10 mol % Butadiene

In a 1-liter three-necked flask provided with stirrer, reflux condenser and nitrogen feed line, 250 g of N-vinyl-n-butyramide and 8 g of dodecyl mercaptan are dissolved in 500 ml of ethanol and flushed with nitrogen. 2 g of dibenzoyl peroxide are added and the mixture is heated at the boiling point of the ethanol for 12 h. In the course of this heating, 13.28 g of butadiene (in gaseous form) are introduced. The copolymer is isolated by stripping off the solvent under reduced pressure. The product obtained has an LCST of 30° C.

### EXAMPLE 17

### Copolymer of 50 mol % Vinylcaprolactam, 45 mol % Vinyl-Pyrrolidine and 5 mol % Glycidyl Methacrylate with Subsequent Modification with 5 mol % Methacrylic Acid

In a 2-liter three-necked flask provided with stirrer, reflux condenser and nitrogen feed line, 138.2 g of N-vinylcaprolactam and 50.9 g of N-vinylpyrrolidone are dissolved in 600 ml of toluene, flushed with nitrogen and heated to the boiling point of the toluene. Added dropwise to this solution is a mixture of 10.9 g of glycidyl methacrylate and 2.5 g of azobisisobutyronitrile in 80 ml of ethanol and the reaction mixture is stirred at the same temperature for a further five hours. The copolymer is modified by reacting it with 6.6 g of methacrylic acid at about 80° C. for a further five hours. The acid can also be added in portions or continuously during the reaction. The product obtained has an LCST of about 46° C.

### EXAMPLE 18

### Copolymer of 50 mol % Vinylcaprolactam, 45 mol % Vinyl-Pyrrolidine and 5 mol % Methacrylic Acid with Subsequent Modification with 5 mol % Glycidyl Methacrylate

In a 2-liter three-necked flask provided with stirrer, reflux condenser and nitrogen feed line, 138.2 g of N-vinylcaprolactam and 50.9 g of N-vinylpyrrolidone are dissolved in 600 ml of toluene, flushed with nitrogen and heated to the boiling point of the toluene. Added dropwise to this solution is a mixture of 6.6 g of methacrylic acid and 2.5 g of azobisisobutyronitrile in 80 ml of ethanol and the reaction mixture is stirred at the same temperature for a further five hours. The copolymer is modified by reacting it with 10.9 g of glycidyl methacrylate at about 80° C. for a further five hours. The methacrylate can also be added in portions or continuously during the reaction. The product obtained has an LCST of about 48° C.

### EXAMPLE 19

### Copolymer of 50 mol % Vinylcaprolactam, 45 mol % Vinyl-Pyrrolidone and 5 mol % α,α-dimethyl-meta-isopropenyl-benzyl Isocyanate with Subsequent Modification with 5 mol % hydroxyethyl methacrylate

In a 2-liter three-necked flask provided with stirrer, reflux condenser and nitrogen feed line, 135.2 g of N-vinylcaprolactam, 49.8 g of N-vinylpyrrolidone and 15.0 g of α,α-dimethyl-meta-isopropenylbenzyl isocyanate are dissolved in 600 ml of toluene, flushed with nitrogen and heated to the boiling point of the toluene. Added dropwise to this solution is a solution of 2.5 g of azobisisobutyronitrile in 80 ml of toluene and the reaction mixture is stirred at the same temperature for a further five hours. The copolymer is modified by reacting it with 10.9 g of hydroxyethyl methacrylate at about 80° C. for a further five hours. The acid can also be added in portions or continuously during the reaction. The product obtained has an LCST of about 50° C.

### EXAMPLE 20

### Copolymer of 50 mol % Vinylcaprolactam, 45 mol % Vinyl-Pyrrolidone and 5 mol % Hydroxyethyl Methacrylate with Subsequent Modification with 5 mol % α,α-dimethyl-meta-isopropenylbenzyl Isocyanate

In a 2-liter three-necked flask provided with stirrer, reflux condenser and nitrogen feed line, 135.2 g of N-vinylcaprolactam, 49.8 g of N-vinylpyrrolidone and 10.9 g of hydroxyethyl methacrylate are dissolved in 600 ml of toluene, flushed with nitrogen and heated to the boiling point of the toluene. Added dropwise to this solution is a solution of 2.5 g of azobisisobutyronitrile in 80 ml of toluene and the reaction mixture is stirred at the same temperature for a further five hours. The copolymer is modified by reacting it with 15.0 g of α,α-dimethyl-meta-isopropenylbenzyl isocyanate at about 80° C. for a further five hours. The isocyanate can also be added in portions or continuously during the reaction. The product obtained has an LCST of about 50° C.

### EXAMPLE 21 (COMPARATIVE)

### LCST Polymer with Only Two Functional Groups for Immobilization on the Particle

a) Preparation of the Initiator Solution

In a 2-liter three-necked flask with reflux condenser, mounted with a drying tube, and nitrogen feed line, 1000 ml of tetrahydrofuran, distilled repeatedly over sodium, 40 g of naphthalene and 6 g of sodium chips are stirred at 20° C. under an absolutely dry nitrogen atmosphere. Over the course of 2 h the sodium passes into solution, to form the addition compound, which is deep green in color. The solution prepared is then 0.25 molar with respect to sodium.

b) Implementation of the Polymerization:

The following operations must likewise be carried out with careful exclusion of air and moisture.

A 1-liter three-necked flask is charged under a pure nitrogen atmosphere with 300 ml of tetrahydrofuran freshly distilled over sodium. Then 20 ml of the naphthalene-sodium solution from a) are transferred to a dropping funnel mounted on the flask, and a few drops of this solution are used to remove the final impurities in the flask. As soon as the green color is maintained, 500 ml of this 0.25 M solution are run in. Subsequently, over the course of 30 minutes and with vigorous stirring, a solution of 317 g of N,N-diethyl-acrylamide (2.5 mol) in 1000 ml of tetrahydrofuran is added dropwise. The solution changes color immediately. External cooling is used to maintain the temperature at 15 to 20° C., and the N,N-diethylacrylamide added dropwise undergoes polymerization virtually in a few seconds. After the end of the addition of N,N-diethyl-acrylamide the polymerization is terminated by addition of an excess of 12 g of acryloyl chloride. The reaction mixture is worked up by adding 10 ml of methanol before the solvent is stripped off. The product obtained has an average molar mass of about 4700 g/mol and an LCST of about 39° C.

### EXAMPLE 22 (COMPARATIVE)

### LCST Polymer with two Functional Groups for Immobilization on the Particle

The polymerization of 348 g (2.5 mol) of N-vinylcaprolactam takes place in the same way as that of the N,N-diethylacrylamide of Example 21. The product obtained has an average molar mass of about 5700 g/mol and an LCST of about 32° C.

### EXAMPLE 23 (COMPARATIVE)

### LCST Polymer with two Functional Groups for Immobilization on the Particle

The polymerization of 145 g (2.5 mol) of methyl vinyl ether takes place in the same way as that of the N,N-diethylacrylamide of Example 21. The sticky product obtained has an average molar mass of about 2500 g/mol and an LCST of about 28 to 30° C.

### USE EXAMPLES

A pearlescent pigment (Iriodin Afflair® 504, manufacturer: Merck KgaA, Darmstadt) is coated with the LCST polymers according to the product versions from the examples. To investigate the efficiency of the polymeric coating of particles, the use of platelet-shaped pearlescent pigments has proven appropriate. For this purpose the water absorption of a paint containing the inventively coated pearlescent pigments is measured. The point of interest here is the comparison between the polymer coatings with high and low degrees of crosslinking or without crosslinking.

### USE EXAMPLE 1

For the treatment of Iriodin Afflair® 504 with the LCST polymer from Example 1, a 0.5% strength polymer solution is used. The pigment (10% by weight) is dispersed in water at 800 rpm for 15 minutes. The dispersion is subsequently cooled to a temperature of 10° C. Following the addition of the polymer solution, the pigment is coated with the polymer at 40° C. for 30 minutes, and the precipitated polymer is then crosslinked for 3 h. The initiator system used is, per gram of polymer, 0.8 g of sodium pyrosulfite, 0.4 g of iron(II) sulfate and 0.8 g of potassium peroxodisulfate. The polymer concentration, based on pigment, was 5% by weight.

### USE EXAMPLE 2

Iridion Afflair® is treated in a similar way with the LCST polymer from Example 2, the temperature of the pigment dispersion being raised from 10° C. to 40° C. for the coating of the pigment. The polymer layer is crosslinked using the polymerization initiator from Use Example 1 over a period of 3 h.

### USE EXAMPLE 3

Iriodin Afflair® 504 is treated in a similar way with the LCST polymer from Example 3, the temperature of the pigment dispersion being raised from 10° C. to 40° C. for the coating of the pigment. The polymer layer is crosslinked using the polymerization initiator from Use Example 1 over a period of 3 h.

### USE EXAMPLE 4

Iriodin Afflair® 504 is treated in a similar way with the LCST polymer from Example 4, the temperature of the pigment dispersion being raised from 10° C. to 40° C. for the coating of the pigment. The polymer layer is crosslinked using the polymerization initiator from Use Example 1 over a period of 3 h.

### USE EXAMPLE 5

Iriodin Afflair® 504 is treated in a similar way with the LCST polymer from Example 5, the temperature of the pigment dispersion being raised from 10° C. to 40° C. for the coating of the pigment. The polymer layer is crosslinked using the polymerization initiator from Use Example 1 over a period of 3 h.

### USE EXAMPLE 6

Iriodin Afflair® 504 is treated in a similar way with the LCST polymer from Example 6, the temperature of the pigment dispersion being raised from 10° C. to 40° C. for the coating of the pigment. The polymer layer is crosslinked using the polymerization initiator from Use Example 1 over a period of 3 h.

### USE EXAMPLE 7

Iriodin Afflair® 504 is treated in a similar way with the LCST polymer from Example 7, the temperature of the pigment dispersion being raised from 10° C. to 40° C. for the coating of the pigment. The polymer layer is crosslinked using the polymerization initiator from Use Example 1 over a period of 3 h.

### USE EXAMPLE 8

Iriodin Afflair® 504 is treated in a similar way with the LCST polymer from Example 8, the temperature of the pigment dispersion being raised from 10° C. to 40° C. for the coating of the pigment. The polymer layer is crosslinked using the polymerization initiator from Use Example 1 over a period of 3 h.

### USE EXAMPLE 9

Iriodin Afflair® 504 is treated in a similar way with the LCST polymer from Example 9, the temperature of the pigment dispersion being raised from 10° C. to 40° C. for the coating of the pigment. The polymer layer is crosslinked using the polymerization initiator from Use Example 1 over a period of 3 h.

### USE EXAMPLE 10

Iriodin Afflair® 504 is treated in a similar way with the LCST polymer from Example 10, the temperature of the pigment dispersion being raised from 10° C. to 40° C. for the coating of the pigment. The polymer layer is crosslinked using the polymerization initiator from Use Example 1 over a period of 3 h.

### USE EXAMPLE 11

Iriodin Afflair® 504 is treated in a similar way with the LCST polymer from Example 11, the temperature of the pigment dispersion being raised from 10° C. to 40° C. for the coating of the pigment. The polymer layer is crosslinked using the polymerization initiator from Use Example 1 over a period of 3 h.

### USE EXAMPLE 12

Iriodin Afflair® 504 is treated in a similar way with the LCST polymer from Example 12, the temperature of the pigment dispersion being raised from 10° C. to 40° C. for the coating of the pigment. The polymer layer is crosslinked using the polymerization initiator from Use Example 1 over a period of 3 h.

### USE EXAMPLE 13

Iriodin Afflair® 504 is treated in a similar way with the LCST polymer from Example 13, the temperature of the pigment dispersion being raised from 10° C. to 40° C. for the coating of the pigment. The polymer layer is crosslinked using the polymerization initiator from Use Example 1 over a period of 3 h.

### USE EXAMPLE 14

Iriodin Afflair® 504 is treated in a similar way with the LCST polymer from Example 14, the temperature of the pigment dispersion being raised from 10° C. to 40° C. for the coating of the pigment. The polymer layer is crosslinked using the polymerization initiator from Use Example 1 over a period of 3 h.

### USE EXAMPLE 15

Iriodin Afflair® 504 is treated in a similar way with the LCST polymer from Example 15, the temperature of the pigment dispersion being raised from 10° C. to 40° C. for the coating of the pigment. The polymer layer is crosslinked using the polymerization initiator from Use Example 1 over a period of 3 h.

### USE EXAMPLE 16

Iriodin Afflair® 504 is treated in a similar way with the LCST polymer from Example 16, the temperature- of the pigment dispersion being raised from 10° C. to 40° C. for the coating of the pigment. The polymer layer is crosslinked using the polymerization initiator from Use Example 1 over a period of 3 h.

### USE EXAMPLE 17

Iriodin Afflair® 504 is treated in a similar way with the LCST polymer from Example 17, the temperature of the pigment dispersion being raised from 10° C. to 55° C. for the coating of the pigment. The polymer layer is crosslinked using the polymerization initiator from Use Example 1 over a period of 3 h.

### USE EXAMPLE 18

Iriodin Afflair® 504 is treated in a similar way with the LCST polymer from Example 18, the temperature of the pigment dispersion being raised from 10° C. to 55° C. for the coating of the pigment. The polymer layer is crosslinked using the polymerization initiator from Use Example 1 over a period of 3 h.

### USE EXAMPLE 19

Iriodin Afflair® 504 is treated in a similar way with the LCST polymer from Example 19, the temperature of the pigment dispersion being raised from 10° C. to 55° C. for the coating of the pigment. The polymer layer is crosslinked using the polymerization initiator from Use Example 1 over a period of 3 h.

### USE EXAMPLE 20

Iriodin Afflair® 504 is treated in a similar way with the LCST polymer from Example 20, the temperature of the pigment dispersion being raised from 10° C. to 55° C. for the coating of the pigment. The polymer layer is. crosslinked using the polymerization initiator from Use Example 1 over a period of 3 h.

### USE EXAMPLE 21 (COMPARATIVE)

Iriodin Afflair® 504 is treated in a similar way with the LCST polymer from Example 21 (Comparative), which contains only two polymerizable groups for immobilization, in each case at the ends of the polymer. In this case the temperature of the pigment dispersion is raised from 10° C. to 45° C. for the coating of the pigment. The polymer layer is crosslinked using the polymerization initiator from Use Example 1 over a period of 3 h.

### USE EXAMPLE 22 (COMPARATIVE)

Iriodin Afflair® 504 is treated in a similar way with the LCST polymer from Example 22 (Comparative), which contains only two polymerizable groups for immobilization, in each case at the ends of the polymer. In this case the temperature of the pigment dispersion is raised from 10° C. to 45° C. for the coating of the pigment. The polymer layer is crosslinked using the polymerization initiator from Use Example 1 over a period of 3 h.

### USE EXAMPLE 23 (COMPARATIVE)

Iriodin Afflair® 504 is treated in a similar way with the LCST polymer from Example 23 (Comparative), which contains only two polymerizable groups for immobilization, in each case at the ends of the polymer. In this case the temperature of the pigment dispersion is raised from 10° C. to 45° C. for the coating of the pigment. The polymer layer is crosslinked using the polymerization initiator from Use Example 1 over a period of 3 h.

### USE EXAMPLE 24 (COMPARATIVE)

Iriodin Afflair® 504 is coated in a similar way with a PEO-PPO-PEO block copolymer of 4400 g/mol with an LCST temperature of 8° C. (available from Aldrich) . In this case the temperature of the pigment dispersion is raised from 5° C. to 20° C. for the coating of the pigment. The polymer layer is crosslinked using the polymerization initiator from Use Example 1 over a period of 3 h.

The pigment samples were tested as follows:

Water Immersion Test:

For the test a conventional paint system for automotive finishes was used, with the following composition:

| Product | Weight fraction | Manufacturer |
|---|---|---|
| Effect pigment | 61.0 | |
| Butyl acetate | 61.0 | |
| Xylene | 35.5 | |
| Cerafak 106 | 120.0 | BYK Cera by |
| Setal 90173 SS-50 | 320.0 | Akzo Nobel Resins |
| Dow Corning 56 | 7.0 | Dow Corning |
| Byik P104 S | 0.5 | BYK Chemie GmbH |
| CAB 381-0.5 | 360 | Eastman Chemicals |
| Butyl acetate | 35.0 | |

The pigment samples were incorporated into the paint system and the test samples were produced as films using the doctor blade (500 μm coat thickness). Testing was carried out in a one-coat system after 16 hours at 66° C. and after 20 hours at 80° C. The test samples are half-immersed in distilled water. The visual assessment of the graying after weathering was made in accordance with ISO 105-A02 24 hours after the end of exposure. The assessment scale ranges from 5 (very good) to 1 (very poor).

Condensation Water Test:

For the test, a waterborne paint system was used, with the following composition:

| Product | Weight fraction | Manufacturer |
|---|---|---|
| Part 1: | | |
| Setalux 6802 | 480 | Akzo Nobel Resins |
| Setamine MS 155 AQ-80 | 47 | Akzo Nobel Resins |
| Butyl glycol | 41 | |
| Deionized water | 255 | |
| Dimethylethanolamine | 10 | |
| (10%) | | |
| Part 2: | | |
| Effect pigment | 37.5 | |
| Butyl glycol | 33.0 | |
| Setal 6306 SS-60 | 31.5 | Akzo Nobel Resins |
| Dimethylethanolamine | 1.0 | |
| Setal 640.7 SQ-26 | 64 | Akzo Nobel Resins |

| | |
|---|---|
| Dimethylethanolamine | Amount different |
| | (pH of the mixture of about 7.8) |
| Latekoll D or | BASF AG |
| Deionized water | Amount different |
| | (viscosity of the mixture of about |
| | 28 s DIN Cup 4) |

The pigment samples were also incorporated into the waterborne paint system and the test samples were produced as films with the doctor blade (500 μm coat thickness). Testing was carried out in accordance with DIN 50017 (constant condensation water climate) 10 minutes to one hour after the end of exposure.

The assessment of the blistering was made visually in accordance with DIN 53209. The evaluation scale ranges from 0 (very good) to 5 (very poor).

The swelling process was assessed visually along the lines of DIN 53230. In the relative evaluation scale the FIG. 0 has the following meaning: “unchanged” and the FIG. 5 has the following meaning: “greatly changed”.

The blank sample shows that even a pure waterborne paint system, i.e., without pigment fraction, likewise absorbs water and slight swelling occurs.

The comparison of the results of measurement in Table 1 shows clearly that the inventively coated pigments have a higher stability in waterborne paint systems than the pigments coated with the comparison polymers (Ex. 21, 22, 23, 24). The tighter crosslinking of the polymers of the invention leads to a greater barrier effect, thereby effectively preventing the penetration of water into the coating polymer.

TABLE I

| | Water immersion test | | Condensation |
|---|---|---|---|
| Example | 16 h/66° C. | 20 h/80° C. | water test |
| 1 | 5-4 | 4-5 | 1.1 |
| 2 | 5 | 5-4 | 1.0 |
| 3 | 5-4 | 4 | 1.0 |
| 4 | 5 | 5-4 | 1.1 |
| 5 | 5 | 5-4 | 1.2 |
| 6 | 5 | 5-4 | 1.1 |
| 7 | 5 | 4 | 1.1 |
| 8 | 5 | 5-4 | 1.0 |
| 9 | 5 | 5-4 | 1.2 |
| 10 | 5 | 4-5 | 1.2 |
| 11 | 5 | 4-5 | 1.0 |
| 12 | 5 | 5-4 | 1.1 |
| 13 | 5-4 | 4 | 1.1 |
| 14 | 5 | 5-4 | 1.1 |
| 15 | 5-4 | 4 | 1.0 |
| 16 | 5 | 5-4 | 1.0 |
| 17 | 5-4 | 5-4 | 1.1 |
| 18 | 5 | 5-4 | 1.0 |
| 19 | 5-4 | 5 | 1.0 |
| 20 | 5 | 5-4 | 1.1 |
| 21 | 4-5 | 4 | 1.9 |
| (Comparative) | | | |
| 22 | 4-5 | 4-3 | 1.6 |
| (Comparative) | | | |
| 23 | 5-4 | 4 | 2.1 |
| (Comparative) | | | |
| 24 | 4 | 4-3 | 2.8 |
| (Comparative) | | | |
| Blank sample | | | 1.2 |

### USE EXAMPLE 25

A semiconductor wafer with a silicon dioxide surface measuring 1×1 cm is immersed in 3 ml of distilled water. It is cooled to 10° C., and then 0.2 ml of a 10% strength by weight LCST copolymer solution from Example 1 is added. After two hours at 10° C. the solution is heated to 40° C. over the course of an hour. Thereafter it is cooled to 10° C. again, but only for a period of 10 minutes, and heated to 40° C. within an hour. This cycle of cooling and heating is carried out a total of three times. After the final cycle the wafer remains for 24 hours in the liquid coating medium at 40° C. and is subsequently rinsed off with distilled water. The polymer layer is then crosslinked under thermal induction; for this purpose the wafer is heated in a drying oven at temperatures of 70 to 100° C. for five hours. Another possibility for crosslinking the polymer layer consists in irradiating the coated wafer for five hours with intense visible light.

In a similar way the silicon wafer is treated with the LCST polymer according to Examples 2 to 16, the temperature range of the polymer solution in the coating operation corresponding to those of the respective use examples. The crosslinking operation takes place in the same way as for the polymer of Example 1.

The semiconductor wafer coated by the process described above with the LCST polymer possesses a more strongly hydrophobic surface than a wafer without coating. This can be documented experimentally by droplets of water applied to the surface. The coated surface, which is therefore more hydrophobic, is wetted less well by water than the unmodified surface. The water droplet beads off from the coated wafer; on the surface which has not been modified, the droplet spreads.

1. An LCST polymer obtainable by free-radical co- or terpolymerization in aqueous or alcoholic solution of
A) about 45.0 to 99.9 mol % of at least one monomer or macromonomer featuring a structural unit selected from the group consisting of 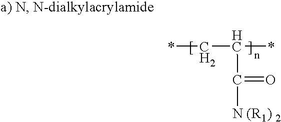
in which n is 1 to 10 000 and R₁ (identical or different at each occurrence) is hydrogen or alkyl groups having 1 to 5 carbon atoms, and the radicals R₁ can also form a ring together with the nitrogen atom; 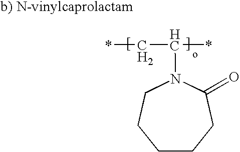
in which o is 1 to 10 000; 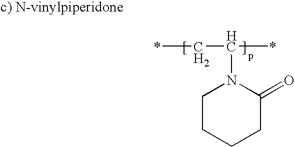
in which p is 1 to 10 000; 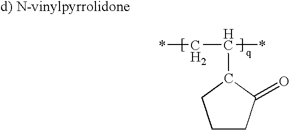
in which q is 1 to 10 000; 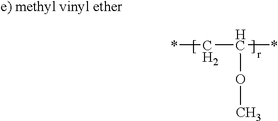
in which r is 1 to 10 000; 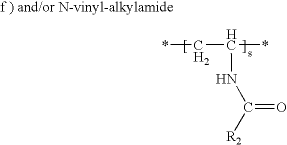
in which s is 1 to 10 000 and R₂ is an (iso)alkyl group having 1 to 5 carbon atoms or a cyclopentyl group; and
B) about 0.1 to 55.0 mol % of a comonomer selected from the group consisting of
a) maleic acid, maleic anhydride or an alkyl ester of maleic acid in which the alkyl group contains 1 to 5 carbon atoms;
b) fumaric acid or an alkyl ester of fumaric acid in which the alkyl group contains 1 to 5 carbon atoms;
c) acrylic or methacrylic acid or an alkyl acrylate or methacrylate in which the alkyl group contains 1 to 5 carbon atoms;
d) a hydroxyalkyl acrylate or methacrylate in which the alkyl group contains 1 to 5 carbon atoms;
e) vinyl acetate;
f) glycidyl (meth)acrylate;
g) allyl glycidyl ether; and/or
h) α,α-dimethyl-meta-isopropenylbenzyl isocyanate; and
mixtures thereof;
wherein the polymer obtained by copolymerizing the monomers or macromonomers (A) and (B) is derivatized by means of a derivatizing agent containing at least one group which is able to react with a group of a repeating unit originating from the comonomer (B), to form a covalent bond, and also at least one polymerizable double bond.

2. The LCST polymer of claim 1, characterized in that the structural unit formed from the comonomers (B) (a) to (c) is derivatized by transesterification with a compound selected from allyl alcohol, hydroxymethyl acrylate, hydroxymethyl methacrylate, hydroxyethyl acrylate, hydroxyethyl methacrylate and 3-amino-1-propanol vinyl ether and by reaction with the corresponding amines of these compounds and mixtures thereof.

3. The LCST polymer of claim 1, characterized in that the structural units formed from the comonomer (B) (d) are derivatized by esterification with a compound selected from acrylic acid with and methacrylic acid or by transesterification with C₁-C₁₀ alkyl acrylates or methacrylates.

4. The LCST polymer of claim 1, characterized in that the structural unit formed from the comonomer (B) (e) is derivatized by transesterification with a compound selected from acrylic acid, methacrylic acid, C₁-C₁₀ alkyl acrylates, and methacrylates and mixtures thereof.

5. The LCST polymer of claim 1, characterized in that the structural unit formed from the comonomer (B) (g) or (h) or its OH-functional or NH-functional derivatives or mixtures thereof is derivatized by reaction with (meth)acrylic acid.

6. The LCST polymer of claim 1, characterized in that the structural units formed from the comonomer (B) (a) to (c) and comprising a carboxylic acid group are derivatized by reaction with glycidyl (meth)acrylate or allyl glycidyl ether or mixtures thereof.

7. The LCST polymer of claim 1, characterized in that the comonomers of group (B) are replaced at least in part by butadiene.

8. The LCST polymer of claim 1, characterized in that the structural unit formed from the comonomer (B) (h) is derivatized by reaction with an unsaturated alcohol.

9. The LCST polymer of claim 1, characterized in that the structural unit formed from the comonomer (B) (d) is derivatized by reaction with α,α-dimethyl-meta-isopropenylbenzyl isocyanate.

10. A process for preparing the LCST polymer of claim 1 comprising subjecting, about 45.0 to 99.9 mol % of at least one monomer or macromonomer (A) and about 0.1% to 55.0% by weight of a comonomer (B) to a free-radical polymerization to produce a resulting polymer; and derivatizing the resulting polymer with a derivatizing agent containing at least one group which is able to react with a group of a repeating unit originating from the comonomer (B), to form a covalent bond, and also containing at least one polymerizable double bond.

11. (canceled)

12. A process for producing coated particles or nonparticulate substrates comprising contacting the particle or the nonparticulate substrate with the LCST polymer of claim 1 in a liquid medium at below an LCST temperature, raising the temperature to above the LCST temperature, and polymerizing the polymers by its double bonds at this temperature or a higher temperature on the surface of the particles or on the nonparticulate substrate surfaces.

13. Coated particles or nonparticulate substrates produced according to the process of claim 11 with the polymerized LCST polymer.

14. The LCST polymer of claim 9, characterized in that the unsaturated alcohol is selected from a group consisting of allyl alcohol, hydroxymethyl acrylate, hydroxymethyl methacrylate, hydroxyethyl acrylate, hydroxyethyl methacrylate, 3-amino-1-propanol vinyl ether and mixtures thereof.
